(19) United States
(12) Patent Application Publication
(10) Pub. No.: US 2023/0403237 A1
(43) Pub. Date: Dec. 14, 2023

(54) PACKET AND MESSAGE TRACKING AND DELIVERY IN REMOTE MEMORY ACCESS CONFIGURATIONS

(71) Applicant: Meta Platforms, Inc., Menlo Park, CA (US)

(72) Inventors: Arvind SRINIVASAN, San Jose, CA (US); Nicolaas Johannes Viljoen, San Bruno, CA (US); Pankaj Kansal, Fremont, CA (US); Ashay Narsale, Newark, CA (US)

(73) Assignee: Meta Platforms, Inc., Menlo Park, CA (US)

(21) Appl. No.: 17/835,517

(22) Filed: Jun. 8, 2022

(51) Int. Cl. H04L 47/34; H04L 47/36

(52) U.S. Cl. CPC H04L 47/34; H04L 47/36

(57) ABSTRACT

According to examples, a system for aligning a plurality of variously encoded content streams is described. The system may include a processor and a memory storing instructions. The processor, when executing the instructions, may cause the system to receive a request to transmit one or more packets of a message over a network, upon receive the request, designate a message sequence number (MSN) for the message, and upon receive the request, designate a packet sequence number (PSN) for one or more packets of the message. The processor, when executing the instructions, may then upon receive the request, designate a flow sequence number (FSN) for each of the one or more packets of the message, populate, utilizing one or more of the message sequence number (MSN) for the message, the packet sequence number (PSN) for one or more packets of the message, and the flow sequence number (FSN) for each of the one or more packets of the message, a sequence tracking array associated with the message, and initiate, utilizing the sequence tracking associated with the message, a recovery protocol in association with a packet of the one or more packets of the message.

### TECHNICAL FIELD

This patent application relates generally to generation and delivery of data, and more specifically, to systems and methods for packet and message tracking and delivery in remote memory access configurations.

### BACKGROUND

With recent advances in technology, prevalence and proliferation of content creation and delivery has increased greatly in recent years. Content creators are continuously looking for ways to deliver more appealing content.

To select a content item from a library of content items that will be of interest to a viewer, a content distributor often may analyze the library of content items to predict a click-through rate (CTR). In some examples, to predict click-through rate (CTR) associate with a particular content item, a content distributor may implement a high-performance artificial intelligence (AI) application.

In some instances, implementation of a high-performance artificial intelligence (AI) application, such as a neural network, may be computationally intensive. In some examples, the computational intensity may lead to various network issues such as latency, wherein a network delay may manifest as a result of delayed, dropped, or lost packets.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1A illustrates a block diagram of a system environment, including a system, for packet and message tracking and delivery in remote memory access configurations, according to an example.

FIG. 1B illustrates a block diagram of the system for packet and message tracking and delivery in remote memory access configurations, according to an example.

FIG. 1C illustrates a system environment for packet and message tracking and delivery in remote memory access configurations, according to an example.

FIG. 1D illustrates a data tracker to implement packet and message tracking and delivery in remote memory access configurations, according to an example.

FIG. 1E illustrates a sequence tracking array to implement packet and message tracking and delivery in remote memory access configurations, according to an example.

FIG. 2 illustrates a block diagram of a computer system for packet and message tracking and delivery in remote memory access configurations, according to an example.

FIG. 3 illustrates a method for packet and message tracking and delivery in remote memory access configurations, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Advances in content management and media distribution are causing users of mobile computing devices to engage with content on or from a variety of content platforms. With the proliferation of different types of digital content delivery mechanisms (e.g., mobile phone devices, tablet devices, etc.), it has become crucial that a content distributor to find new ways to facilitate user engagement a viewer with delivered content that is of interest to them.

Typically, a content platform having one or more content items may be provided by a service provider. Examples of digital content items include, but are not limited to, digital images, digital video files, digital audio files, and/or streaming content. Examples of types of content that may be shared over various content platforms may include audio (e.g., podcasts, music), video (e.g., music videos, variety shows, sports, etc.), and text (e.g., micro-blogs, blogs, etc.).

To select a content item that will be of interest to a viewer, a content distributor often may analyze a library of content items to determine one or more associations between the viewer and each of the content items in the library. To indicate a degree of association between a viewer and a content item, a content distributor may utilize a quantifiable metric to generate a ranking. One such quantifiable metric may be a probability associated with a click-through rate (CTR).

In some examples, to predict a click-through rate (CTR) for a particular content item, a content distributor may implement a high-performance artificial intelligence (AI) application. For example, one such artificial intelligence (AI) application may be a neural network (NN). In one example, a neural network (NN) may include one or more computing devices configured to implement one or more machine-learning (ML) algorithms to “learn” by progressively extracting higher-level information from input data.

In some instances, implementation of a high-performance artificial intelligence (AI) application may be computationally intensive. That is, as a number of aspects to be considered by the high-performance artificial intelligence (AI) application may increase, computational complexity may increase as well, often exponentially.

In some examples, issues associated with computational intensity in implementing a high-performance artificial intelligence (AI) application may manifest via latency. In some examples, “latency” may be used to describe a time delay that may occur in transferring data between a first source device and a second destination device on a network. In some examples, this latency may be introduced as a result of packets that may be delayed, dropped, or lost.

Implementation of a high-performance artificial intelligence (AI) application may, in some examples, come with substantial network bandwidth demands. As such, in many instances, any network congestion may directly affect latency, and thereby may affect performance of the high-performance artificial intelligence (AI) application.

In some examples, one type of latency that may manifest may be tail-end latency. In some examples, “tail-end latency” may refer to a particular percentage of network response times among a totality of response times that may take the longest response times.

In many instances, network congestion may directly affect tail latencies and may negatively affect network performance of a high-performance artificial intelligence (AI) application. Accordingly, in some instances, it may be beneficial to attempt to reduce tail-end latencies, and to provide predictable tail-end latencies as well.

In some examples, various techniques may be utilized to address issues associated with network latency. For example, in some instances, certain memory access techniques may be utilized to provide more efficient transfer of data between a first (e.g., source) device and a second (e.g., destination) device.

One such example of a memory access technique may be remote direct memory access (RDMA). In some examples, remote direct memory access (RDMA) may be implemented as a direct memory access from a memory of a first device into that of a second device, without involving either device's operating system. As such, in some examples, this may permit low-latency data transfer between massively parallel computer clusters, such as the kind that may be utilized to implement a high-performance artificial intelligence (AI) application.

In some examples, data loss recovery techniques may be utilized to address issues associated with network latency. In some examples, network latency may result from data (e.g., packets) that may be lost or dropped. In some examples, implementation of efficient data recovery protocols may serve to limit network latency.

In some examples, yet another technique that may be utilized may be in-cast avoidance. In some instances, where many network elements may be transmitting data to a particular (receiving) network element at a particular time, the (receiving) network element may become overwhelmed. In particular, in some instances, this may render the (receiving) network element unable to buffer data (e.g., packets) at a sufficient rate, and may result in a throughput “collapse” for the network. In these instances, in-cast avoidance may be implemented to avoid overwhelming receiving network elements.

In some examples, another technique that may be utilized to address latency issues may be a per-packet load balancing scheme. In some examples, “per-packet load balancing” may refer to a technique for mitigating network congestion “hotspots” by, at each network switch, selecting one output port to independently forward each (incoming) packet. In some examples, selection of this output port may be based on a cost (i.e., a shortest path) to reach a particular destination. It may be appreciated that implementation of this technique may require calculation of shortest paths in advance.

In some examples, a per-packet load balancing scheme may be implemented as part a packet spraying scheme. In some examples, “packet spraying” may include spreading of a network load across all available paths (or “links”). In some examples, to implement per-packet load balancing, an available path may be selected according to various criteria. In one example, a first available path may be selected. In another examples, a path that may provide a lowest delivery (i.e., transfer) cost may be selected. In yet another example, a path may be selected according to an available quality of service (QoS).

It may be appreciated that upon spraying data (e.g., packets) across various available paths, the sprayed data may be received at a destination location in a non-sequential (i.e., out of order) manner. Accordingly, it may be necessary to, upon receipt of the sprayed data, to (re)arrange the received data so that it may be delivered (e.g., transmitted to a user device) in a continuous and in-order manner.

In some examples, to implement packet spraying in a large-scale network, it may be challenging to keep track of data elements (e.g., packets) that may be delayed, dropped, or lost, or that may require re-transmission. Moreover, it may be difficult to determine when a dropped, delayed, or lost packet may (eventually) arrive at a receiving network element. Accordingly, in an example involving a large-scale network, implementation of a packet spraying scheme may typically require significant buffering capacities, especially at end nodes.

In addition, implementation of a packet spraying scheme may provide additional challenges as well. For example, it may be difficult in some instances to distinguish between a delayed packet (i.e., a packet that is being transferred but not on time) and a dropped packet (i.e., a packet that is no longer in the process of transfer). In some examples, to distinguish between a delayed packet and a dropped packet, it may be necessary for a network to implement a timer for each data element (e.g., packet) to be transferred. However, it may be appreciated that such a requirement may significantly alter power profiles for various network elements (e.g., a network interface controller (NIC)). Furthermore, this may also require significant tuning of network parameters and timeout schemes.

In implementing a packet spraying technique over a network, it may be beneficial, in some instances, to provide a credit-based arrangement. In particular, since data (e.g., packets) may not be arriving a continuous and/or sequential manner, the network elements may be arranged to operate “on faith” that a given data element (e.g., packet) will be delivered. In some examples, this credit arrangement may also be referred to as “link-level flow credit.”

In some examples, a link-level flow credit arrangement may provide, among other things, a bandwidth capacity, a bandwidth usage, and an available bandwidth for each network element on a network. In some examples, this information may be utilized to distribute (i.e., “spray”) data among the network elements accordingly. In these examples, each network element may implement a credit-based scheme, wherein a destination element may make itself available (i.e., on “credit”) to receive a packet from a source element. As a result, in some instances, data loss rates for networks implementing link-level flow credit may be minimal and/or relatively rare.

It may be appreciated that, in some examples, networks that may not support link level credit flow may not be able to provide reliable and predictable transfer to data between network elements. In particular, in situations where link-level credit flow may not be implemented, it may difficult to determine if a data element (e.g., a packet) may be delayed, dropped, or lost. Also, in some examples, it may difficult to determine whether a data element may be eventually received (e.g., via retransmission) at all.

In some examples, systems and methods for packet and message tracking and delivery are provided. In some examples, the systems and methods may provide efficient distribution and re-assembly of data (e.g., messages, packets, etc.) to enable, among other things, packet spraying implementations in networks. In particular, in some examples, the systems and methods may be implemented to provide remote direct memory access (RDMA) data transfer. Furthermore, in some examples, the systems and methods may be implemented for to enable high-performance artificial intelligence (AI) applications.

In some examples, the systems and methods may enable packet spraying for networks that may not implement link-level flow credit. Accordingly, in some examples, the systems and methods may reduce network latency by minimizing delayed, dropped, and lost data (e.g., messages, packets, etc.).

In some examples, to reduce network latency, the systems and methods describe may, among other things, implement one or more sequence indicators. As used herein, a “sequence indicator” may include any data element that may be utilized to track and/or deliver data from a first (e.g., source) network location to a second (e.g., destination) network location. In some examples, the sequence indicator may be a sixteen (16) bit number, which may, in some instances, require approximately five (5) milliseconds (ms) of round-trip time (RTT) on a 400G cloud infrastructure link utilizing a four (4) kilobyte maximum transfer unit (MTU).

In some examples, one or more sequence indicators may be included in a header of a packet to be transferred over a network. So, for examples, in some instances, a controller may be utilized to add a header that may be utilized by a network element (e.g., a network switch) to route data within the network. Indeed, as discussed in further detail below, the systems and methods described may alter (e.g., add, change, etc.) mutable fields in a packet header to include the one or more sequence indicators, wherein the one or more sequence indicators may be utilized to track, deliver, and/or route data over the network.

In some examples, one or more sequence indicators may each take the form a sequential and monotonically increasing number that a network element (e.g., a network controller) may utilize to track data transferred over the network. Accordingly, in some examples, to detect data (e.g., a packet) that may be delayed, dropped, or lost, the systems and methods may enable a network element (e.g., a network controller) to track these monotonically increasing sequence numbers and to detect a missing number (i.e., a “hole”) that may indicate data (e.g., a packet) that may be delayed, dropped, or lost.

In some examples and as will be discussed in further detail below, a first sequence indicator that may be implemented by the systems and methods described may be a message sequence number (MSN). In some examples, the message sequence number (MSN) may be utilized to designate a particular data message that may be transferred over a network.

In some examples and as will be discussed in further detail below, a second sequence indicator that may be implemented by the systems and methods described may be a packet sequence number (PSN). In some examples, the packet sequence number may be utilized to designate a particular packet within a message to be transferred over a network. In some examples, the packet sequence number (PSN) may take the form of a locational “offset” within the message.

In some examples and as will be discussed in further detail below, a third sequence indicator that may be implemented by the systems and methods described may be a flow sequence number (FSN). In some examples, the flow sequence number (FSN) may be utilized to designate a particular path over which a data message may be transferred over a network.

In some examples, to implement one or more sequence indicators as described herein, the systems and methods described may implement a data tracker. In some examples, the data tracker may be a computational element that may, for any data transferred over a network, create and/or track one or more message sequence numbers (MSNs), packet sequence numbers (PSNs), and/or flow sequence numbers (FSNs) associated with the data transferred over the network.

In some examples, to track data transferred over a network, the systems and methods may provide (e.g., via use of a data tracker) a sequence tracking array that may include one or more message sequence numbers (MSNs), packet sequence numbers (PSNs), and/or flow sequence numbers (FSNs) associated with data transferred over the network. In some examples, the systems and methods may utilize the sequence tracking array to track data (e.g., packets) to be transferred, including delayed, dropped, or lost data. In particular, in some examples, the systems and methods may utilize one or more of sequence indicators to request re-transmission of a data element (e.g., a packet).

In some examples, a system as described may include a processor and a memory storing instructions, which when executed by the processor, may cause the processor to receive a request to transmit one or more packets of a message over a network and upon receiving the request, designate a message sequence number (MSN) for the message, designate a packet sequence number (PSN) for the one or more packets of the message, and designate a flow sequence number (FSN) for each of the one or more packets of the message. In addition, in some examples, the instructions may further cause the processor to populate, utilizing one or more of the message sequence number (MSN) for the message, the packet sequence number (PSN) for the one or more packets of the message, and the flow sequence number (FSN) for each of the one or more packets of the message, a sequence tracking array associated with the message and initiate, utilizing the sequence tracking array associated with the message, a recovery protocol in association with a packet of the one or more packets of the message.

In some examples, the instructions may further cause the processor to generate a global sequence number (GSN) based on a message sequence number (MSN) for a message and a packet sequence number (PSN) for one or more packets of a message. Furthermore, in some examples, the instructions may cause the processor to provide a message completion indicating that one or more packets of the message may have reached a destination element on the network. In some examples, indicating a message completion may include implementing a completion pointer.

In some examples, a message sequence number (MSN) for a message may be a unique and/or incrementing number. Also, in some examples, each packet sequence number (PSN) for the one or more packets of the message may represent an offset based on a maximum transmission unit (MTU) for a network device on the network. In addition, in some examples, a packet sequence number (PSN) for one or more packets of a message may be a unique, incrementing and/or monotonically incrementing number.

In some examples, a method for implementing configurable packet and message tracking and delivery as described may include, among other things, receiving a request to transmit one or more packets of a message over a network, designating, upon receive the request, a message sequence number (MSN) for the message, designating, upon receive the request, a packet sequence number (PSN) for the one or more packets of the message, and designating, upon receive the request, a flow sequence number (FSN) for each of the one or more packets of the message. Furthermore, in some examples, the method may also include populating, utilizing one or more of the message sequence number (MSN) for the message, the packet sequence number (PSN) for the one or more packets of the message, and the flow sequence number (FSN) for each of the one or more packets of the message, a sequence tracking array associated with the message and initiating, utilizing the sequence tracking array associated with the message, a recovery protocol in association with a packet of the one or more packets of the message.

In some examples, a non-transitory computer-readable storage medium as described may have an executable stored thereon which when executed instructs a processor to receive a request to transmit one or more packets of a message over a network, and upon receive the request, designate a message sequence number (MSN) for the message, designate a packet sequence number (PSN) for the one or more packets of the message, and designate a flow sequence number (FSN) for each of the one or more packets of the message. In addition, the executable when executed may further instruct a processor to populate, utilizing one or more of the message sequence number (MSN) for the message, the packet sequence number (PSN) for the one or more packets of the message, and the flow sequence number (FSN) for each of the one or more packets of the message, a sequence tracking array associated with the message and initiate, utilizing the sequence tracking array associated with the message, a recovery protocol in association with a packet of the one or more packets of the message.

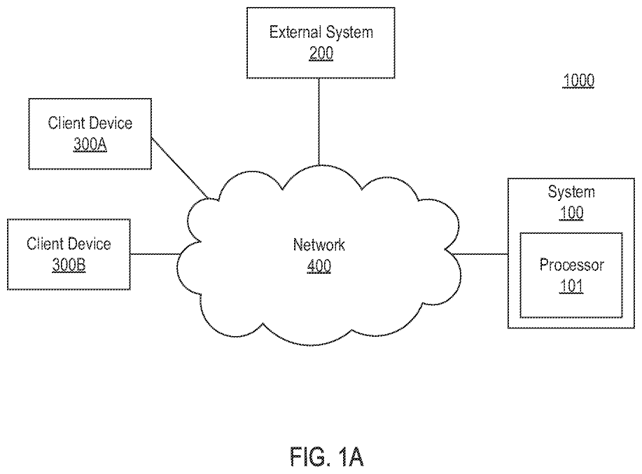

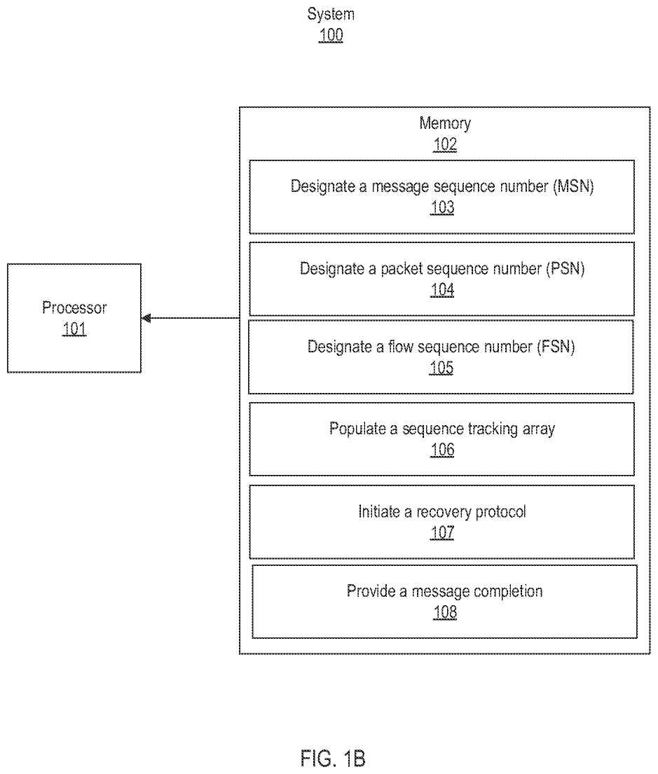

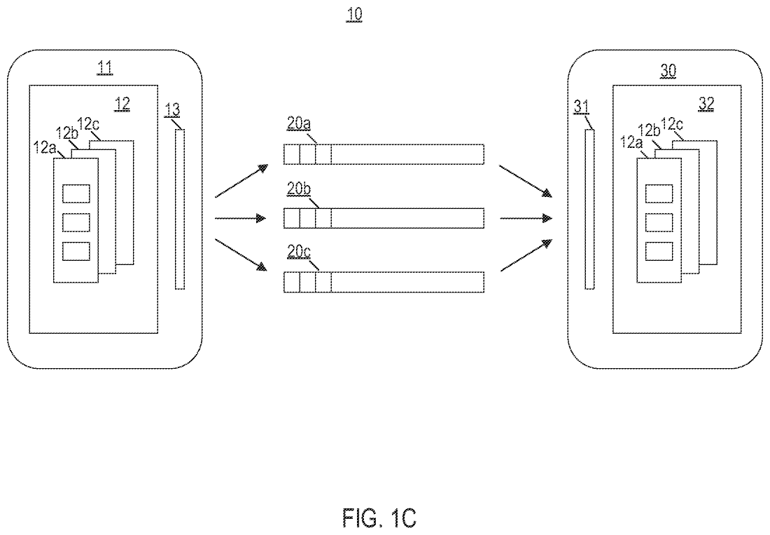

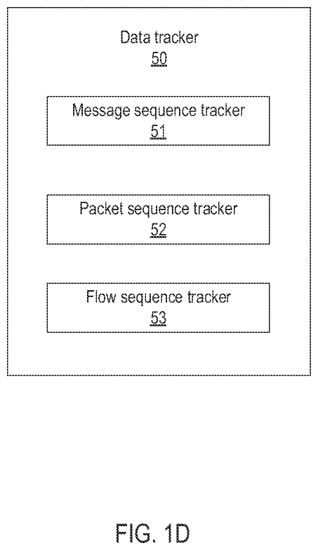

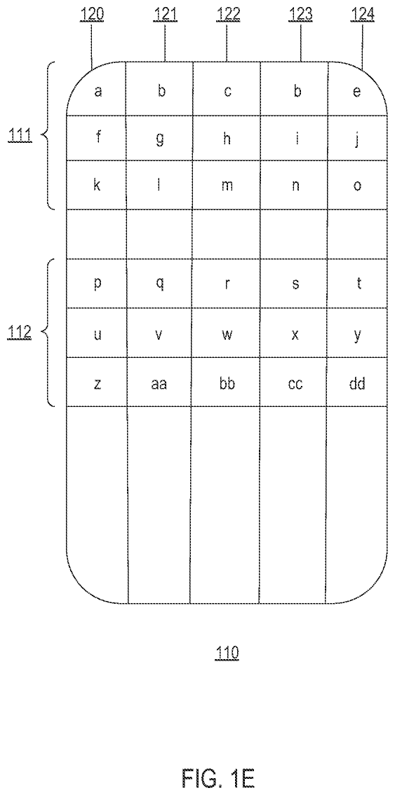

Reference is now made to FIGS. 1A-1E. FIGS. 1A-1E illustrate various aspects of one or more system environments, including one or more systems, for packet and message tracking and delivery in remote memory access configurations. As used herein, “remote memory access” may include any instance where a first network element in a network may request data from a second network element in the network. In particular, FIG. 1A illustrates a block diagram of a system environment, including a system, for packet and message tracking and delivery in remote memory access configurations, according to an example. FIG. 1B illustrates a block diagram of the system for packet and message tracking and delivery in remote memory access configurations, according to an example.

As will be described in the examples below, one or more of system 100, external system 200, user devices 300A-300B and system environment 1000 shown in FIGS. 1A-1B may be operated by a service provider to provide packet and message tracking and delivery in remote memory access configurations. It should be appreciated that one or more of the system 100, the external system 200, the user devices 300A-300B and the system environment 1000 depicted in FIGS. 1A-1B may be provided as examples. Thus, one or more of the system 100, the external system 200 the user devices 300A-300B and the system environment 1000 may or may not include additional features and some of the features described herein may be removed and/or modified without departing from the scopes of the system 100, the external system 200, the user devices 300A-300B and the system environment 1000 outlined herein.

While the servers, systems, subsystems, and/or other computing devices shown in FIGS. 1A-1B may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 100, the external system 200, the user devices 300A-300B or the system environment 1000.

It should also be appreciated that the systems and methods described herein may be particularly suited for digital content, but are also applicable to a host of other distributed content or media. These may include, for example, content or media associated with data management platforms, search or recommendation engines, neural networks (NN), social media, and/or data communications involving communication of potentially personal, private, or sensitive data or information. These and other benefits will be apparent in the descriptions provided herein.

In some examples, the external system 200 may include any number of servers, hosts, systems, and/or databases that store data to be accessed by the system 100, the user devices 300A-300B, and/or other network elements (not shown) in the system environment 1000. In addition, in some examples, the servers, hosts, systems, and/or databases of the external system 200 may include one or more storage mediums storing any data. In some examples, and as will be discussed further below, the external system 200 may be utilized to store any information. As will be discussed further below, in other examples, the external system 200 may be utilized by a service provider (e.g., a social media application provider) as part of a data storage.

In some examples, the user devices 300A-300B may be electronic or computing devices configured to transmit and/or receive data. In this regard, each of the user devices 300A-300B may be any device having computer functionality, such as a television, a radio, a smartphone, a tablet, a laptop, a watch, a desktop, a server, encoder, or other computing or entertainment device or appliance. In some examples, the user devices 300A-300B may be mobile devices that are communicatively coupled to the network 400 and enabled to interact with various network elements over the network 400. In some examples, the user devices 300A-300B may execute an application allowing a user of the user devices 300A-300B to interact with various network elements on the network 400. Additionally, the user devices 300A-300B may execute a browser or application to enable interaction between the user devices 300A-300B and the system 100 via the network 400.

The system environment 1000 may also include the network 400. In operation, one or more of the system 100, the external system 200 and the user devices 300A-300B may communicate with one or more of the other devices via the network 400. The network 400 may be a local area network (LAN), a wide area network (WAN), the Internet, a cellular network, a cable network, a satellite network, or other network that facilitates communication between, the system 100, the external system 200, the user devices 300A-300B and/or any other system, component, or device connected to the network 400. The network 400 may further include one, or any number, of the exemplary types of networks mentioned above operating as a stand-alone network or in cooperation with each other. For example, the network 400 may utilize one or more protocols of one or more clients or servers to which they are communicatively coupled. The network 400 may facilitate transmission of data according to a transmission protocol of any of the devices and/or systems in the network 400. Although the network 400 is depicted as a single network in the system environment 1000 of FIG. 1A, it should be appreciated that, in some examples, the network 400 may include a plurality of interconnected networks as well.

In some examples, and as will be discussed further below, the system 100 may be configured to track and deliver data in remote memory access configurations. Details of the system 100 and its operation within the system environment 1000 will be described in more detail below.

As shown in FIGS. 1A-1B, the system 100 may include processor 101 and the memory 102. In some examples, the processor 101 may be configured to execute the machine-readable instructions stored in the memory 102. It should be appreciated that the processor 101 may be a semiconductor-based microprocessor, a central processing unit (CPU), an application specific integrated circuit (ASIC), a field-programmable gate array (FPGA), and/or other suitable hardware device.

In some examples, the memory 102 may have stored thereon machine-readable instructions (which may also be termed computer-readable instructions) that the processor 101 may execute. The memory 102 may be an electronic, magnetic, optical, or other physical storage device that contains or stores executable instructions. The memory 102 may be, for example, random access memory (RAM), an Electrically Erasable Programmable Read-Only Memory (EEPROM), a storage device, an optical disc, or the like. The memory 102, which may also be referred to as a computer-readable storage medium, may be a non-transitory machine-readable storage medium, where the term “non-transitory” does not encompass transitory propagating signals. It should be appreciated that the memory 102 depicted in FIGS. 1A-1E may be provided as an example. Thus, the memory 102 may or may not include additional features, and some of the features described herein may be removed and/or modified without departing from the scope of the memory 102 outlined herein.

It should be appreciated that, and as described further below, the processing performed via the instructions on the memory 102 may or may not be performed, in part or in total, with the aid of other information and data, such as information and data provided by the external system 200 and/or the user devices 300A-300B. Moreover, and as described further below, it should be appreciated that the processing performed via the instructions on the memory 102 may or may not be performed, in part or in total, with the aid of or in addition to processing provided by other devices, including for example, the external system 200 and/or the user devices 300A-300B.

FIG. 1C illustrates a system environment 10 that may be implemented for packet and message tracking and delivery in remote memory access configurations, according to an example. In some examples, the system environment 10 may include a first (e.g., source) network device 11, a second (e.g., destination) network device 30, and a plurality of paths (or “paths”) 20a-c. As will be discussed in further detail below, the first network device 11 may implement packet spraying to spray packets associated with one or messages over the plurality of paths 20a-20c.

In some examples, the first network device 11 may include a first memory 12 and a spraying component 13. In some examples, the memory 12 may include one or more messages 12a-12c, each of which may be comprised of one or more packets to be transferred to the second network device 30. In some examples, the spraying component 13 may receive each of the one or more packets from the memory 12, and may spray the one or more packets over the plurality of paths 20a-20c. In particular, in one example, the spraying component 13 may spray a first packet of the message 12a to the path 20a, may spray a second packet of the message 12a to the path 20b, may spray a third packet of the message 12a to the path 20c, and so on.

In some examples, each of the plurality of paths 20a-20c may have a path identification (ID). In some examples, the path identification (ID) of each of the plurality of paths 20a-20c may take the form of alphanumeric characters. In some examples, the path identification (ID) for each of the plurality of paths may be unique. In some examples, the plurality of paths 20a-20c may be utilized to implement packet spraying and to deliver the one or more messages 12a-12c to the second network device 30.

In some examples, the second network device 30 may include a receiving component 31 and a second memory 32. In some examples and as will be discussed further below, the receiving component 31 may receive the (incoming) sprayed packets (associated with the one or more messages 12a-12c) via the plurality of paths 20a-20c. In some examples, the receiving component 31 may assemble the (incoming) sprayed packets associated with the one or more messages 12a-12c to form the one or more messages 12a-12c. In some examples, the receiving component 31 may store the (incoming) sprayed packets in the second memory 32.

FIG. 1D illustrates a data tracker 50 that may be implemented for packet and message tracking and delivery in remote memory access configurations, according to an example. In some examples, the data tracker 50 may be implemented via and/or in association with executable instructions on computer memory, such as the instructions on the memory 102 on the system 100.

In some examples, the data tracker 50 may include a message sequence tracker 51. In particular, in some examples, for each message located in a memory (e.g., the memory 102) and to be transferred, the message sequence tracker 51 may track a message sequence number (MSN) associated with the message.

In some examples and as will be discussed further below, if the data tracker 50 may receive a communication indicating that one or more packets associated with a particular message may have been delayed, dropped, or lost, the message sequence tracker 51 may utilize an associated message sequence number (MSN) to determine where the one or more packets may be located and to re-transmit the one or more packets to a destination device.

In some examples, the data tracker 50 may include a packet sequence tracker 52. In particular, in some examples, for each packet located in a memory (e.g., the memory 102) and to be transferred, the packet sequence tracker 52 may track a packet sequence number (PSN) associated with the packet. Accordingly, in some examples and as will be discussed further below, if the data tracker 50 may receive a communication indicating that one or more packets associated with a particular message may have been delayed, dropped, or lost, the packet sequence tracker 52 may utilize a packet sequence number (PSN) associated with the one or more packets to determine where the packets may be located and to re-transmit the one or more packets to a destination device.

In some examples, the data tracker 50 may include a flow sequence tracker 52. In particular, in some examples, for each packet located in a memory (e.g., the memory 102) to be transferred, the flow sequence tracker 52 may track a path number or path identification associated with the packet. That is, in some examples, the flow sequence tracker 52 may track a flow sequence number (FSN) for each message to be transferred, where the flow sequence number (FSN) may identify which path may be associated with a transfer of the packet.

In some examples and as will be discussed further below, if the data tracker 50 may receive a communication indicating that one or more packets associated with a particular message may have been delayed, dropped, or lost, the flow sequence tracker 52 may utilize an associated flow sequence number (FSN) to determine a path associated with the one or more packets and to re-transmit the one or more packets to a destination device.

In some examples, the memory 102 may store instructions, which when executed by the processor 101, may cause the processor to: designate a message sequence number (MSN); designate a packet sequence number (PSN); designate a flow sequence number (FSN); populate a sequence tracking array; initiate a recovery protocol; and provide a message completion.

It may be appreciated that, in some examples, the instructions 103-108 may be executed in association with one or more data trackers (e.g., similar to the data tracker 50 in FIG. 1D). In particular, in some examples, some of the features described in relation to the instructions 103-108 may be performed by the one or more data trackers. In other examples, the features described in relation to the instructions 103-108 may be performed exclusively by the one or more data trackers.

In some examples, and as discussed further below, the instructions 103-108 on the memory 102 may be executed alone or in combination by the processor 101 to provide packet and message tracking and delivery in remote memory access configurations. In some examples, the instructions 103-108 may be implemented in association with a content platform configured to provide content for users, while in other examples, the instructions 103-108 may be implemented as part of a stand-alone application.

Additionally, and as described above, it should be appreciated that to provide generation and delivery of content, instructions 103-108 may be configured to utilize various artificial intelligence (AI) and machine learning (ML) based tools. For instance, these artificial intelligence (AI) and machine learning (ML) based tools may be used to generate models that may include a neural network (e.g., a recurrent neural network (RNN)), generative adversarial network (GAN), a tree-based model, a Bayesian network, a support vector, clustering, a kernel method, a spline, a knowledge graph, or an ensemble of one or more of these and other techniques. It should also be appreciated that the system 100 may provide other types of machine learning (ML) approaches as well, such as reinforcement learning, feature learning, anomaly detection, etc.

In some examples, the instructions 103 may designate a message sequence number (MSN). In some examples, the instructions 103 may designate a message sequence number (MSN) for each of one or more messages to be transmitted over a network. In some examples, the instructions 103 may receive a request to transmit one or more packets of a message over a network.

As discussed above, in some examples, a message sequence number (MSN) may be utilized to indicate a location (i.e., an address) that each message may be written (i.e., in memory) to. Furthermore, in some examples, the instructions 103 may be configured to include a message sequence number (MSN) within a transport header of a packet for purposes of, among other things, packet spraying and message assembly.

In some examples, each message sequence number (MSN) associated with one or more messages may be a unique and/or incrementing number (e.g., an alphanumeric number). In addition, in some examples, each message sequence number (MSN) may be of a predetermined size (e.g., thirty-two (32) bits). Furthermore, in some examples, the instructions 103 may further determine a message length, determine a message start (i.e., a start of the message), and determine a message end (i.e., an end of the message).

Accordingly, as will discussed in greater detail, upon receiving an indication of a delayed, dropped, and/or lost packet associated with a message, a corresponding message sequence number (MSN) may be utilized to locate the message in a memory and to transmit or re-transmit some or all of the message to a destination location.

Furthermore, in some examples, the message sequence number (MSN) may be used by the instructions 103 to determine where to write (incoming) packets. For example, in some instances, the instructions 103 may enable a receiving (i.e., destination) device to determine where to write (incoming) packets so that the packets may be arranged in a correct order.

It should be appreciated that, in some examples, the instructions 103 may operate in conjunction with a data tracker (e.g., the data tracker 50). In some examples, the data tracker may utilize a message sequence number (MSN) to track locations of one or more messages to be transmitted over a network.

In some examples, the instructions 104 may designate a packet sequence number (PSN). In some examples, the instructions 104 may designate a packet sequence number (PSN) for each packet of one or more messages to be transmitted over a network.

As discussed above, in some examples, a packet sequence number (PSN) may be utilized to indicate a packet ordering of a message. In particular, in some examples, the instructions 104 may utilize the packet sequence number (PSN) for each of the one or more packets of a message to receive the one or more packets in an out-of-order manner and to arrange the one or more packets of the message in a correct order.

In some examples, a packet sequence number (PSN) may represent an offset for a particular packet from a start of a message. In some examples, the packet sequence number (PSN) may represent an offset (i.e., a number) that may be utilized to write a packet to a correct memory address. In some examples, the instructions 104 may implement an offset that may be based on a maximum transmission unit (MTU) for a network device. In particular, in some examples, if a packet may be a fifth packet within a message, the (corresponding) offset may be five (5) times the maximum transmission unit (MTU) for the network device. In some examples, this offset may be utilized to determine a memory location to write a packet to.

Furthermore, in some examples, the instructions 104 may include a packet sequence number (PSN) within a transport header of a packet for purposes of, among other things, packet spraying and message assembly. For example, in some instances, the instructions 104 may enable to a receiving (i.e., destination) device to determine where to write (incoming) packets so that the packets may be arranged in a correct order.

In some examples, each packet sequence number (PSN) associated with one or more messages may be a unique, incrementing and/or monotonically incrementing number (e.g., an alphanumeric number). In addition, in some examples, each packet sequence number (PSN) may be of a predetermined size (e.g., thirty-two (32) bits). Accordingly, as will discussed in greater detail, upon receiving an indication of a delayed, dropped, and/or lost packet associated with a message, a corresponding packet sequence number (PSN) may be utilized to locate the packet in a memory and to transmit or re-transmit the packet to a destination location.

It should be appreciated that, in some examples, the instructions 104 may operate in conjunction with a data tracker (e.g., the data tracker 50). In some examples, the data tracker may create a packet sequence number (PSN) for a packet and may utilize the packet sequence number (PSN) to track a location of a packet to be transmitted over a network.

In addition, some examples, the instructions 104 may generate a global message sequence number (GSN). In some examples, the global message sequence number (GSN) may include a message sequence number (MSN) (e.g., as derived via the instructions 103) and a packet sequence number (PSN) (e.g., as derived via the instructions 104).

In some examples, the instructions 104 may utilize the global message sequence number (GSN) to queue and track message data into a receiving data memory and to determine an associated address, and also to determine a message start, a message end, and a message count indicating an amount of data to be transmitted or received so that a corresponding completion indication may be sent upon completion of transmission.

In some examples, the instructions 105 may designate a flow sequence number (FSN). In some examples, the instructions 105 may designate a flow sequence number (FSN) for each packet of one or more messages to be transmitted over a network. In particular, in some examples the instructions 105 may create and implement a flow sequence number (FSN) for each packet in association with a (transfer) path.

In some examples, a path designated by the flow sequence number (FSN) may be a path over which a corresponding packet may be transmitted to reach a destination device. In some examples and as discussed above, the instructions 105 may designate a flow sequence number (FSN) according to a quality of service (QoS) indication for one or more available paths.

In some examples, the instructions 105 may utilize the flow sequence number (FSN) for each of the one or more packets of a message to receive the one or more packets in an out-of-order manner and to arrange the one or more packets of the message in a correct order. Also, in some examples, the flow sequence number (FSN) may be utilized by a receiving device to distinguish between a delayed packet and a dropped packet when reassembling incoming packets.

In some examples, the instructions 105 may include a flow sequence number (FSN) within a transport header of a packet for purposes of, among other things, packet spraying and message assembly. In some examples, each flow sequence number (FSN) associated with one or more messages may be a unique, incrementing, and/or monotonically incrementing number (e.g., an alphanumeric number).

In addition, in some examples, each flow sequence number (FSN) may be of a predetermined size (e.g., sixteen (16), twenty-four (24), or thirty-two (32) bits). Accordingly, as will discussed in greater detail, upon receiving an indication of a delayed, dropped, and/or lost packet associated with a message, a corresponding flow sequence number (FSN) may be utilized to locate the packet in a memory and to transmit or re-transmit the packet to a destination location.

It should be appreciated that, in some examples, the instructions 105 may operate in conjunction with a data tracker (e.g., the data tracker 50). In some examples, the data tracker may create a flow sequence number (FSN) for a packet and may utilize a flow sequence number (FSN) to track a location of a packet to be transmitted over a network.

In some examples, the instructions 106 may populate a sequence tracking array. In some examples, the instructions 106 may generate and populate a sequence tracking array associated with one or more messages to be transferred over a network. In some examples, the sequence tracking array generated via the instructions 106 may be utilized to provide information associated with (and among other things) the one or more messages, one or more packets associated with the one or more messages, and one or more paths that the one or more messages may be transmitted over.

In some examples, the instructions 106 may generate and populate a sequence tracking array upon a scheduling a packet of a message for transmission. Furthermore, in some examples, the instructions 106 may update the sequence tracking array every time a (associated) packet may be scheduled for transmission.

In some examples, the instructions 106 may enable a transmitting device to utilize the sequence tracking array (and associated monotonically incrementing sequence indicators) to determine which packets of message may be transmitted. In addition, in some examples, the instructions 106 may enable a receiving device to utilize the sequence tracking array to determine which packets may be incoming.

FIG. 1E illustrates a sequence tracking array 110 to implement packet and message tracking and delivery in remote memory access configurations, according to an example. In some examples, the sequence tracking array 110 may be generated and implemented (i.e., populated) by or in conjunction with the instructions 106. In some examples, the sequence tracking array 110 may include one or more message sequence indicators, such as a message sequence number (MSN), a packet sequence number (PSN), a global message sequence number (GSN), and/or a flow sequence number (FSN).

It may be appreciated that, in some examples, each element (i.e., slot) of the sequence tracking array 110 may not be occupied. In some examples, because each element of the sequence tracking array 110 may not be occupied, the sequence tracking array 110 may display an incomplete arrangement. Furthermore, it may be appreciated that an arrangement of the sequence tracking array may change over time, depending on various criteria associated with an associated network (e.g., quality of service (QoS), etc.).

In some examples, one or more rows of the sequence tracking array 110 may be associated with a message to be transmitted. In some examples, upon scheduling of a message for transmission, the instructions 106 may provide a slot in the sequence tracking array 110 for each packet of a message, wherein each entry in the sequence tracking array 110 may represent an offset into an associated message (e.g., a location offset for a location of a packet).

In the example illustrated in FIG. 1E, a first message having a message sequence number (MSN) 111 and a second message having a message sequence number (MSN) 112 may be tracked in the sequence tracking array 110. In particular, the packet sequence numbers (PSNs) a-o of the first message having a message sequence number (MSN) 111 may be tracked via the sequence tracking array 110. In addition, the packet sequence numbers (PSNs) p-dd of the second message having a message sequence number (MSN) 112 may be tracked via the sequence tracking array 110 as well.

In some examples, the instructions 106 may be configured to, utilizing the sequence tracking array 110, spray one packet of each of the first message having a message sequence number (MSN) 111 and the second message having a message sequence number (MSN) 112 per path of available paths having flow sequence numbers (FSNs) 120-124. In particular, in some examples, the packets of having packet sequence numbers (PSNs) a, f, k of the first message having a message sequence number (MSN) 111 may be transmitted utilizing a path having a flow sequence number (FSN) 120. Similarly, in some examples, the packets of having packet sequence numbers sequence (PSNs) b, g, l of the first message having a message sequence number (MSN) 111 may be transmitted utilizing a path having a flow sequence number (FSN) 121. Accordingly, in this manner, the packets having the packet sequence numbers a-o of the first message having a message sequence number (MSN) 111 may be transmitted and tracked over the available paths having flow sequence numbers (FSNs) 120-124.

In some examples, the packets of having packet sequence numbers sequence (PSNs) p, u, z of the second message having a message sequence number (MSN) 112 may be transmitted utilizing a path having a flow sequence number (FSN) 120. Similarly, in some examples, the packets of having packet sequence numbers sequence (PSNs) q, v, aa of the second message having a message sequence number (MSN) 112 may be transmitted utilizing a path having a flow sequence number (FSN) 121. Accordingly, in this manner, the packets having the packet sequence numbers p-dd of the second message having a message sequence number (MSN) 112 may be transmitted and tracked over the available paths 120-124.

It may be appreciated that the sequence tracking array 110 implemented by the instructions 106 may be utilized to track packets of messages and a determine if a packet may have been delayed, dropped, or lost. In particular, in some examples, to determine if each packet of a message may have been transmitted properly or may have been delayed, dropped, or lost, the instructions 106 may determine whether an acknowledgement (ACK) for each packet may have been received. Moreover, in some examples, in an event that a packet may have been delayed, dropped, or lost, and a re-transmission of the packet may be required, the instructions 106 may utilize the sequence tracking array 110 to determine a location (e.g., via an associated pointer that may be stored) of the packet in memory.

In some examples, the instructions 107 may initiate a recovery protocol. In particular, in some examples, the instructions 107 may initiate a recovery protocol in association with a packet previously transmitted. In particular, in some examples, the instructions 107 may determine (e.g., via a sequence tracking array implemented via the instructions 106) that a packet may have been delayed, dropped, or lost, and may request that the packet be re-transmitted. In some examples, the instructions 107 may initiate the recovery protocol upon request (e.g., from a destination delivery awaiting the packet).

In some examples, to implement a recovery protocol in association with a packet (e.g., that may have been delayed, dropped, lost), the instructions 107 may track one or more completion pointers associated with one or more packets of a message. In some examples, the instructions 107 may map the tracked completion pointers to each packet sequence number (PSN) in a sequence tracking array, and may determine that a particular packet having a packet sequence number (PSN) in a sequence tracking array (e.g., such as the sequence tracking array 110) may not have been acknowledged. In this instance, in some examples, the instructions 107 may utilize an associated pointer, for example, from a retransmission packet pointer list implemented by the instructions 107, to determine a location of the packet to be re-transmitted. In some examples, the location of the packet may be determined by the instructions 107 via use of one or more of a path in a path list, a length of a message, and/or an offset associated with the packet. It may be appreciated that, in some instance, the instructions 107 may enable re-transmission of the packet in concert with one or more hardware elements.

In some examples, to implement a recovery protocol in association with a packet (e.g., that may have been delayed, dropped, lost), the instructions 107 may selectively recover (i.e., seek re-transmission of) only the packet (or the plurality of packets) that may have previously transmitted (and may have been delayed, dropped, or lost). In other examples, the instructions 107 may recover packets in addition to the packet previously transmitted, such as any and all packets from a point at which a delay, drop, or loss may have occurred.

In some examples, to implement a recovery protocol in association with a packet (e.g., that may have been delayed, dropped, lost), the instructions 107 may implement one of a plurality of recovery protocols. So, in a first example, the instructions 107 may initiate a waiting period for processing until the packet to be recovered may be received. That is, in some examples, the instructions 107 may discontinue receipt and/or processing of any following packets until a preceding packet (i.e., that may have been delayed, dropped, or lost) may be received. In some instances, this may be referred to as a “go-back” technique. In another example, the instructions 107 may continue receipt and/or processing of any following packets while the preceding packet (i.e., that may have been delayed, dropped, or lost) may be being recovered (i.e., re-transmitted).

It may be appreciated that, in some instances, a recovery protocol may be initiated for more than one packet at once. Indeed, in some examples, recovery protocols for a plurality of packets of a first message and a plurality of packets of a second message may be implemented simultaneously.

In some examples, the instructions 108 may indicate (i.e., provide) a message completion. In some examples, upon receipt of one or more packets associated with a message, the instructions 108 may indicate that a packet and/or a message may have reached at destination element on a network.

In some examples, to indicate a message completion, the instructions 108 may implement a completion pointer. In some examples, the completion pointer implemented via the instructions 108 may indicate that one or more incoming packets associated with a message may have been received. In some examples, the indication may take a form of an acknowledgement (ACK), and may be implemented via the instructions 108 in combination with a hardware element that may be utilized to implement a message completion protocol.

In some examples, an acknowledgement (ACK) may be a result of one or more packets being transmitted successfully (i.e., from a source element on a network to a destination element on the network). In some examples, to implement a message completion, a source device may transmit a message to a destination device indicating one or more packets may be incoming. In some examples, to implement a message completion, a destination device may transmit a message to a receiving device indicating successful receipt of the one or more incoming packets.

That is, in some examples, when all packets associated with entries in a sequence tracking array (e.g., the sequence tracking array 110) have been updated, delivered, and acknowledged, the instructions 108 may enable an associated message to be marked for completion (i.e., an update completion descriptor). In some examples, the instructions 108 may transmit a completion event to an application, along with various metadata, pointers, etc.

It may be appreciated that, in some instances, there may be more than one message that may be outstanding on a network, since each message may occupy its own one or more slots in the sequence tracking array. In some examples, the completion entries associated with the one or more messages may be pushed in to the application in a first-in/first-out (FIFO) ordering.

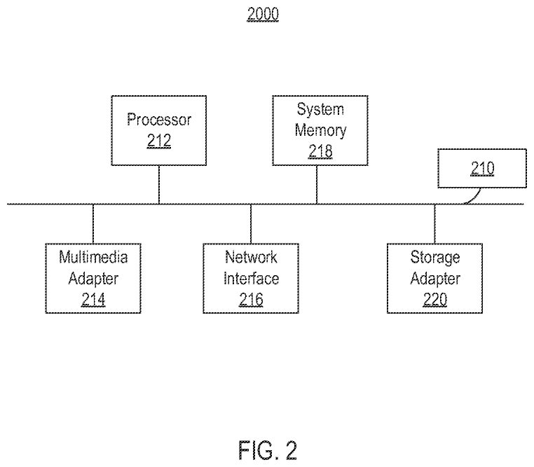

FIG. 2 illustrates a block diagram of a computer system for packet and message tracking and delivery in remote memory access configurations, according to an example. In some examples, the system 2000 may be associated the system 100 to perform the functions and features described herein. The system 2000 may include, among other things, an interconnect 210, a processor 212, a multimedia adapter 214, a network interface 216, a system memory 218, and a storage adapter 220.

The interconnect 210 may interconnect various subsystems, elements, and/or components of the external system 200. As shown, the interconnect 210 may be an abstraction that may represent any one or more separate physical buses, point-to-point connections, or both, connected by appropriate bridges, adapters, or controllers. In some examples, the interconnect 210 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect 210 may allow data communication between the processor 212 and system memory 218, which may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 212 may be the central processing unit (CPU) of the computing device and may control overall operation of the computing device. In some examples, the processor 212 may accomplish this by executing software or firmware stored in system memory 218 or other data via the storage adapter 220. The processor 212 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 214 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 216 may provide the computing device with an ability to communicate with a variety of remote devices over a network (e.g., network 400 of FIG. 1A) and may include, for example, an Ethernet adapter, a Fibre Channel adapter, and/or other wired- or wireless-enabled adapter. The network interface 216 may provide a direct or indirect connection from one network element to another, and facilitate communication and between various network elements.

The storage adapter 220 may connect to a standard computer-readable medium for storage and/or retrieval of information, such as a fixed disk drive (internal or external).

Many other devices, components, elements, or subsystems (not shown) may be connected in a similar manner to the interconnect 210 or via a network (e.g., network 400 of FIG. 1A). Conversely, all of the devices shown in FIG. 2 need not be present to practice the present disclosure. The devices and subsystems can be interconnected in different ways from that shown in FIG. 2. Code to implement the dynamic approaches for payment gateway selection and payment transaction processing of the present disclosure may be stored in computer-readable storage media such as one or more of system memory 218 or other storage. Code to implement the dynamic approaches for payment gateway selection and payment transaction processing of the present disclosure may also be received via one or more interfaces and stored in memory. The operating system provided on system 100 may be MS-DOS, MS-WINDOWS, OS/2, OS X, IOS, ANDROID, UNIX, Linux, or another operating system.

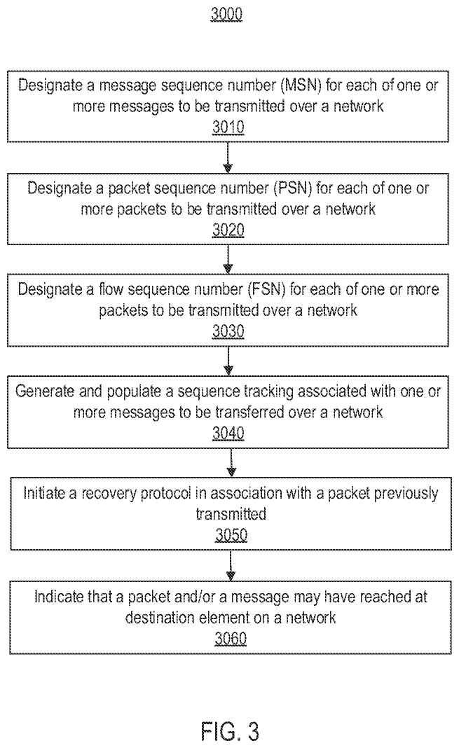

FIG. 3 illustrates a method for packet and message tracking and delivery in remote memory access configurations, according to an example. The method 3000 is provided by way of example, as there may be a variety of ways to carry out the method described herein. Each block shown in FIG. 3 may further represent one or more processes, methods, or subroutines, and one or more of the blocks may include machine-readable instructions stored on a non-transitory computer-readable medium and executed by a processor or other type of processing circuit to perform one or more operations described herein.

Although the method 3000 is primarily described as being performed by system 100 as shown in FIGS. 2A-2B, the method 3000 may be executed or otherwise performed by other systems, or a combination of systems. It should be appreciated that, in some examples, to generate audio and video content based on text content, the method 3000 may be configured to incorporate artificial intelligence (AI) or deep learning techniques. It should also be appreciated that, in some examples, the method 3000 may be implemented in conjunction with a content platform (e.g., a social media platform) to generate and deliver content. In some examples, to implement the steps 3010-3060, the processor 101 may be executed in association with operation of one or more data trackers (e.g., the data tracker 50 in FIG. 1D).

At 3010, in some examples, the processor 101 may designate a message sequence number (MSN) for each of one or more messages to be transmitted over a network. In some examples, the processor 101 may be configured to include a message sequence number (MSN) within a transport header of a packet for purposes of, among other things, packet spraying and message assembly. In some examples, each message sequence number (MSN) associated with one or more messages may be a unique and/or incrementing number (e.g., an alphanumeric number). In addition, in some examples, each message sequence number (MSN) may be of a predetermined size (e.g., thirty-two (32) bits). In some examples, upon receiving an indication of a delayed, dropped, and/or lost packet associated with a message, the processor 101 may utilize a corresponding message sequence number (MSN) to locate the message in a memory and to re-transmit some or all of the message to a destination location.

At 3020, in some examples, the processor 101 may designate a packet sequence number (PSN) for each of one or more packets to be transmitted over a network. In particular, in some examples, the processor 101 may utilize the packet sequence number (PSN) for each of the one or more packets of a message to receive the one or more packets in an out-of-order manner and to arrange the one or more packets of the message in a correct order. In some examples, a packet sequence number (PSN) may represent an offset for a particular packet from a start of a message. Furthermore, in some examples, the processor 101 may include a packet sequence number (PSN) within a transport header of a packet for purposes of, among other things, packet spraying and message assembly. For example, in some instances, the processor 101 may enable to a receiving (i.e., destination) device to determine where to write (incoming) packets so that the packets may be arranged in a correct order. In some examples, each packet sequence number (PSN) associated with one or more messages may be a unique, incrementing and/or monotonically incrementing number (e.g., an alphanumeric number).

At 3030, in some examples, the processor 101 may designate a flow sequence number (FSN) for each of one or more packets to be transmitted over a network. In particular, in some examples the processor 101 may create and implement a flow sequence number (FSN) for each packet in association with a (transfer) path. In some examples, the processor 101 may utilize the flow sequence number (FSN) for each of the one or more packets of a message to receive the one or more packets in an out-of-order manner and to arrange the one or more packets of the message in a correct order. In some examples, the processor 101 may include a flow sequence number (FSN) within a transport header of a packet for purposes of, among other things, packet spraying and message assembly. In addition, in some examples, each flow sequence number (FSN) may be of a predetermined size (e.g., thirty-two (32) bits).

At 3040, in some examples, the processor 101 may populate a sequence tracking array. In some examples, the processor 101 may generate and populate a sequence tracking array associated with one or more messages to be transferred over a network. In some examples, the sequence tracking array generated via the processor 101 may be utilized to provide information associated with (and among other things) the one or more messages, one or more packets associated with the one or more messages, and one or more paths that the one or more messages may be transmitted over. In some examples, the processor 101 may generate and populate a sequence tracking array upon a scheduling a packet of a message for transmission. It may be appreciated that the sequence tracking array by the processor 101 may be utilized to track packets of messages and a determine if a packet may have been delayed, dropped, or lost. In particular, in some examples, to determine if each packet of a message may have been transmitted properly or may have been delayed, dropped, or lost, the processor 101 may determine whether an acknowledgement (ACK) for each packet may have been received.

At 3050, in some examples, the processor 101 may initiate a recovery protocol in association with a packet previously transmitted. In particular, in some examples, the processor 101 may determine (e.g., via a sequence tracking array implemented via the processor 101) that a packet may have been delayed, dropped, or lost, and may request that the packet be re-transmitted. In some examples, the processor 101 may initiate the recovery protocol upon request (e.g., from a destination delivery awaiting the packet).

In some examples, to implement a recovery protocol in association with a packet (e.g., that may have been delayed, dropped, lost), the processor 101 may track one or more completion pointers associated with one or more packets of a message. In some examples, to implement a recovery protocol in association with a packet (e.g., that may have been delayed, dropped, lost), the processor 101 may selectively recover (i.e., seek re-transmission of) only the packet (or the plurality of packets) that may have previously transmitted (and may have been delayed, dropped, or lost). In other examples, the processor 101 may recover packets in addition to the packet previously transmitted, such as any and all packets from a point at which a delay, drop, or loss may have occurred.

At 3060, in some examples, upon receipt of one or more packets associated with a message, the processor 101 may indicate that a packet and/or a message may have reached at destination element on a network. In some examples, to indicate a message completion, the processor 101 may implement a completion pointer. In some examples, to implement a message completion, a source device may transmit a message to a destination device indicating one or more packets may be incoming. In some examples, to implement a message completion, a destination device may transmit a message to a receiving device indicating successful receipt of the one or more incoming packets.

That is, in some examples, when all packets associated with entries in a sequence tracking array (e.g., the sequence tracking array 110) have been updated, delivered, and acknowledged, the processor 101 may enable an associated message to be marked for completion (i.e., an update completion descriptor). In some examples, the processor 101 may transmit a completion event to an application, along with various metadata, pointers, etc.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A system, comprising:
a processor;
a memory storing instructions, which when executed by the processor, cause the processor to:
receive a request to transmit one or more packets of a message over a network;
upon receiving the request:
designate a message sequence number (MSN) for the message;
designate a packet sequence number (PSN) for the one or more packets of the message; and
designate a flow sequence number (FSN) for each of the is one or more packets of the message;
populate, utilizing one or more of the message sequence number (MSN) for the message, the packet sequence number (PSN) for the one or more packets of the message, and the flow sequence number (FSN) for each of the one or more packets of the message, a sequence tracking array associated with the message; and
initiate, utilizing the sequence tracking array associated with the message, a recovery protocol in association with a packet of the one or more packets of the message.

2. The system of claim 1, wherein the message sequence number (MSN) for the message is a unique and incrementing number.

3. The system of claim 1, wherein each packet sequence number (PSN) for the one or more packets of the message represents an offset based on a maximum transmission unit (MTU) for a network device on the network.

4. The system of claim 1, wherein the packet sequence number (PSN) for the one or more packets of the message is a monotonically incrementing number.

5. The system of claim 1, wherein the instructions, when executed by the processor, further cause the processor to:
generate a global sequence number (GSN) based on the message sequence number (MSN) for the message and the packet sequence number (PSN) for the one or more packets of the message.

6. The system of claim 1, wherein the instructions, when executed by the processor, further cause the processor to:
provide a message completion indicating that the one or more packets of the message reached a destination element on the network.

7. The system of claim 6, wherein indicating the message completion includes implementing a completion pointer.

8. A method for implementing packet and message tracking and delivery, comprising:
receiving a request to transmit one or more packets of a message over a network;
designating, upon receive the request, a message sequence number (MSN) for the message;
designating, upon receive the request, a packet sequence number (PSN) for the one or more packets of the message;
designating, upon receive the request, a flow sequence number (FSN) for each of the one or more packets of the message;
populating, utilizing one or more of the message sequence number (MSN) for the message, the packet sequence number (PSN) for the one or more packets of the message, and the flow sequence number (FSN) for each of the one or more packets of the message, a sequence tracking array associated with the message; and
initiating, utilizing the sequence tracking array associated with the message, a recovery protocol in association with a packet of the one or more packets of the message.

9. The method of claim 8, wherein the message sequence number (MSN) for the message is a unique and incrementing number.

10. The method of claim 8, wherein each packet sequence number (PSN) for the one or more packets of the message represents an offset based on a maximum transmission unit (MTU) for a network device on the network.

11. The method of claim 8, wherein the packet sequence number (PSN) for the one or more packets of the message is a monotonically incrementing number.

12. The method of claim 8, further comprising generating a global sequence number (GSN) based on the message sequence number (MSN) for the message and the packet sequence number (PSN) for the one or more packets of the message.

13. The method of claim 8, further comprising providing a message completion indicating that the one or more packets of the message reached a destination element on the network.

14. A non-transitory computer-readable storage medium having an executable stored thereon, which when executed instructs a processor to:
receive a request to transmit one or more packets of a message over a network;
upon receive the request,
designate a message sequence number (MSN) for the message;
designate a packet sequence number (PSN) for the one or more packets of the message; and
designate a flow sequence number (FSN) for each of the one or more packets of the message;
populate, utilizing one or more of the message sequence number (MSN) for the message, the packet sequence number (PSN) for the one or more packets of the message, and the flow sequence number (FSN) for each of the one or more packets of the message, a sequence tracking array associated with the message; and
initiate, utilizing the sequence tracking array associated with the message, a recovery protocol in association with a packet of the one or more packets of the message.

15. The non-transitory computer-readable storage medium of claim 14, wherein the executable when executed further instructs the processor to:
generate a global sequence number (GSN) based on the message sequence number (MSN) for the message and the packet sequence number (PSN) for the one or more packets of the message.

16. The non-transitory computer-readable storage medium of claim 14, wherein the executable when executed further instructs the processor to:
provide a message completion indicating that the one or more packets of the message reached a destination element on the network.

17. The non-transitory computer readable storage medium of claim 16, wherein providing the message completion includes implementing a completion pointer.

18. The non-transitory computer-readable storage medium of claim 14, wherein each packet sequence number (PSN) for the one or more packets of the message represents an offset based on a maximum transmission unit (MTU) for a network device on the network.

19. The non-transitory computer-readable storage medium of claim 14, wherein the message sequence number (MSN) for the message is a unique and incrementing number.

20. The non-transitory computer-readable storage medium of claim 14, wherein the packet sequence number (PSN) for the one or more packets of the message is a monotonically incrementing number.
